(19) United States
(12) Patent Application Publication
(10) Pub. No.: US 2002/0186464 A1
(43) Pub. Date: Dec. 12, 2002

(54) Autofocus microscope system

(75) Inventor: Benedikt Schmalz, Rebstein (CH)

Correspondence Address: FOLEY AND LARDNER, SUITE 500, 3000 K STREET NW, WASHINGTON, DC, 20007, US

(73) Assignee: LEICA MICROSYSTEMS AG

(21) Appl. No.: 10/097,649

(22) Filed: Mar. 15, 2002

(30) Foreign Application Priority Data
Mar. 17, 2001 (DE) 101 13 084.8

(51) Int. Cl. G02B 21/36

(52) U.S. Cl. 359/383; 359/363; 359/368

(57) ABSTRACT

A microscope system is provided comprising a positioning system for positioning at least one microscope objective, an electronic camera unit, and an autofocus device for focusing the positioning system in response to a control signal. The electronic camera unit is comprised of at least one image sensor for generating an acquisition signal representing an acquired microscope image, and a control unit for generating a control signal from the acquisition signal. An autofocus algorithm is implemented in the control unit to generate the control signal from the acquisition signal.

### CROSS-REFERENCE TO RELATED PATENT APPLICATIONS

This invention claims the priority of and benefit to German patent application 101 13 084.8 filed on Mar. 17, 2001 which is incorporated by reference herein in its entirety.

### BACKGROUND OF THE INVENTION

I. FIELD OF THE INVENTION

The invention relates to an autofocus microscope system, and more particularly, to a microscope including an electronic camera for generating a signal representing an autofocus instruction.

II. BACKGROUND OF THE INVENTION

An exemplary autofocus microscope system is the “Leica AF 500” autofocus system. This system includes a stereomicroscope in whose beam path an electronic camera unit having an image sensor can be arranged, in order to acquire a microscope image. The image signals (video data) of the camera unit are read via a control and readout unit into a microprocessor system having a signal processor, and a frame grabber card. With the frame grabber card, the video data are read directly into the working memory of the microprocessor system. The microprocessor system calculates (among other things), on the basis of an algorithm, whether the previous focus position is “sharp” or whether the microscope is “out of focus,” (i.e., not focused). If the microscope is not focused, the microprocessor system generates a positioning signal for the control unit of the microscope, with which the microscope is brought into focus (i.e., an autofocus function).

This autofocus microscope system thus typically requires a comparatively expensive and complexly wired microprocessor unit for focusing. The relatively high cost and complexity is disadvantageous in particular if the microscope image is only intended to be displayed on a monitor and not to be subjected to additional image processing operations, so that ultimately the microprocessor unit is only used for focusing.

The article “Quick trials of a two megapixel digital camera for photomicrography” by Dave Walker, which appeared in the Web magazine Micscape, March 2000, describes a microscope system of a different species in which an autofocus digital camera is mounted on an eyepiece of a microscope and the autofocus capability of the digital camera is used for focusing on the eyepiece image. It is necessary in this context, however, for the microscope to be “prefocused,” (i.e., not to be too far out of focus). This article is incorporated by reference herein in its entirety.

This procedure is difficult, if even possible, to implement without the intervention of a user. In addition, vignetting of the image may occur when the camera is mounted on an eyepiece.

### SUMMARY OF THE INVENTION

An object of the invention is to develop an autofocus microscope system including an electronic camera for generating a signal representing an autofocus instruction, in such a way that the use of expensive components, such as a separate autofocus microprocessor unit, can be eliminated or reduced.

According to one aspect of the present invention, a microscope system is provided comprising a positioning system for controlling at least one microscope objective, an electronic camera unit, and an autofocus device for focusing the positioning system in response to the control signal. The electronic camera unit is comprised of at least one image sensor for generating an acquisition signal representing an acquired microscope image, and a control unit for generating a control signal from the acquisition signal. An autofocus algorithm is implemented in the control unit to generate the control signal from the acquisition signal.

According to another aspect of the present invention, a program product for autofocusing a microscope with an electronic camera is provided, the program product comprising computer readable program code for carrying out the method steps of acquiring a microscope image, generating at least one image signal representing the microscope image, generating an autofocus signal from the at least one image signal via an autofocus algorithm, and controlling a focus positioning unit with the autofocus signal.

According to another aspect of the present invention, a computer readable disc comprising machine readable program code is provided for causing a microscope including an electronic camera to perform the method steps of acquiring a microscope image, generating at least one image signal representing the microscope image, generating an autofocus signal from the at least one image signal via an autofocus algorithm, and controlling a focus positioning unit with the autofocus signal.

According to another aspect of the present invention, a method of focusing a microscope using an electronic camera is provided comprising the steps of acquiring a microscope image, generating at least one image signal representing the microscope image, generating an autofocus signal from the at least one image signal via an autofocus algorithm, and controlling a focus positioning unit with the autofocus signal.

One aspect of the invention is based on the recognition that the control units of digital camera modules, which often include a signal processor, have sufficient computing capacity to generate an autofocus instruction from the signals that represent the image. As a result, because of the procedure according to the present invention, a “software solution” can be utilized instead of a “hardware solution.” This software solution according to the present invention has a definite cost advantage over many known procedures, since it requires only a software implementation and no substantial additional hardware outlay.

The autofocus instruction generated (on a software basis) by the control unit is then applied to an objective positioning unit which controls focusing of the microscope objective or objectives.

It is particularly advantageous that a commercially available control unit for a digital camera, and in particular a commercially available signal processor unit for one or more CCD chips, can be used as the control unit of the camera unit, which performs both the reading-out operation and the software-based generation of the autofocus signal. Control units of this kind can be acquired economically because of the large quantities in which they are manufactured for still shot cameras, in particular for the amateur photographer sector.

Many commercially available and known microscopes, and in particular stereomicroscopes, can be used as the microscope. The camera unit can be arranged at many points known from the existing art. For example, the chip of the camera unit can be arranged at the location of an intermediate image, in particular after the microscope objective or objectives. It is of course also possible to flange-mount the camera unit onto the eyepiece (with the known disadvantages) using a standard flange.

Many other known microscopes, and in particular zoom capable stereomicroscopes, can similarly be used as microscopes. Zoom objectives, and/or objectives having a fixed focal length or adjustable focal length arranged on at least one objective changer, can be utilized as the microscope objectives of the microscopes.

If zoom objectives, and/or objectives arranged on (at least) one objective changer are utilized as the microscope objective or objectives, it is particularly preferred that the focal length adjustment of the zoom objective or objectives and/or the position of the objective changer or changers are also controlled. This control can be accomplished, for example, in such a way that an “optimum” image area is always established.

In order to make the software-based focusing solution provided according to the present invention compatible with a control unit for the microscope and its objectives, it is particularly preferred if the camera control unit and the objective control unit comprise interface units through which they are connected and by way of which compatible transfer of the data or instructions is ensured.

According to an aspect of the present invention, allowing focusing to be performed on a “software basis” by way of the control and readout unit of the camera module is not limited to a specific configuration of the camera unit and of the microscope. On the contrary, the camera unit can be arranged in any manner known per se, in the beam path of the microscope or on the eyepiece or one of the eyepieces, and can be configured in a manner known per se with one or more CCD chips. It is also possible to utilize known microscope embodiments as the microscope.

### BRIEF DESCRIPTION OF THE DRAWINGS

The invention is described in more detail below on the basis of exemplary embodiments, referring to the drawings in which:

FIG. 1 shows a block diagram of a microscope system according to an embodiment of the present invention;

FIG. 2 shows a block diagram of a microscope system according to another embodiment of the present invention; and

FIG. 3 shows a flow chart of a method of focusing a microscope using an electronic camera according to another embodiment of the present invention.

### DETAILED DESCRIPTION OF THE PREFERRED EMBODIMENTS

Reference will now be made in detail to presently preferred embodiments of the present invention. Wherever possible, the same reference numbers will be used throughout the drawings to refer to the same or like parts.

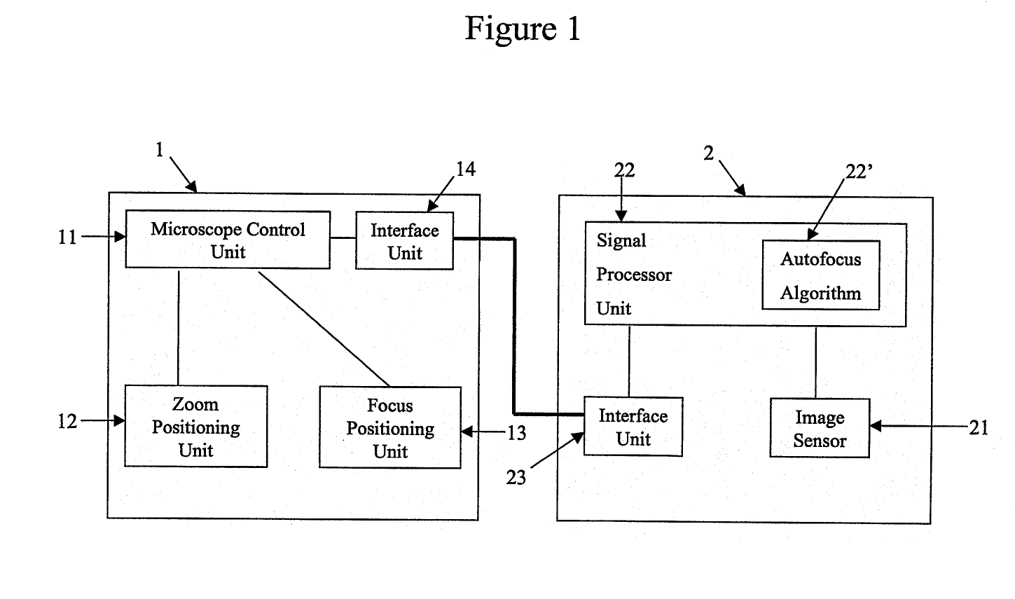

A first exemplary embodiment of the present invention is depicted in FIG. 1. As shown, microscope 1 and electronic camera unit 2 are depicted schematically in the form of a “block diagram.” Microscope 1 comprises, in a manner known per se, at least one or, when the microscope is configured as a stereomicroscope, two microscope objectives. The microscope objectives can be zoom objectives (although the invention is not limited thereto) that allow for, within a specific range (e.g., 1 to 5) a focal length adjustment and thus a magnification adjustment.

To control the microscope objectives in the exemplary embodiment of FIG. 1, a control unit 11 is provided that, via zoom and focus positioning units 12 and 13, controls the focal length adjustment and focusing of the microscope objective or objectives.

Electronic camera unit 2 comprises at least one image sensor 21 for acquiring the microscope image and a signal processor unit 22 for reading out and processing the signals, representing the image, of the image sensor or sensors 21. According to the present invention, an additional algorithm 22′ which ascertains the focus state of the acquired images is integrated into the execution control program of signal processor unit 22. The autofocus function labeled with the reference character 22′ is preferably not an additional hardware element, but rather merely an autofocus algorithm 22′, integrated into the execution controller of signal processor unit 22, that ascertains the optimum focus (e.g., using a contrast method). Other criteria known per se are of course also usable for focusing.

As a function of the focus state that is ascertained, signal processor unit 22 generates an autofocus signal or an autofocus instruction that is forwarded via an interface unit 23 to microscope 1 in order to focus the microscope objective or objectives and thus the images acquired by camera unit 2.

In the exemplary embodiment shown in FIG. 1, interface unit 23 is connected for that purpose to a corresponding interface unit 14 of microscope 1, so that the autofocus instruction generated by signal processor unit 22 is present at control unit 11 which controls positioning unit 13 for focusing the microscope objective or objectives. In addition, control unit 11 can (optionally on the basis of corresponding control signals of signal processor unit 22) control the focal length of the microscope objective via positioning unit 12. The focal length can of course also be controlled on the basis of other criteria, for example on the basis of external control instructions.

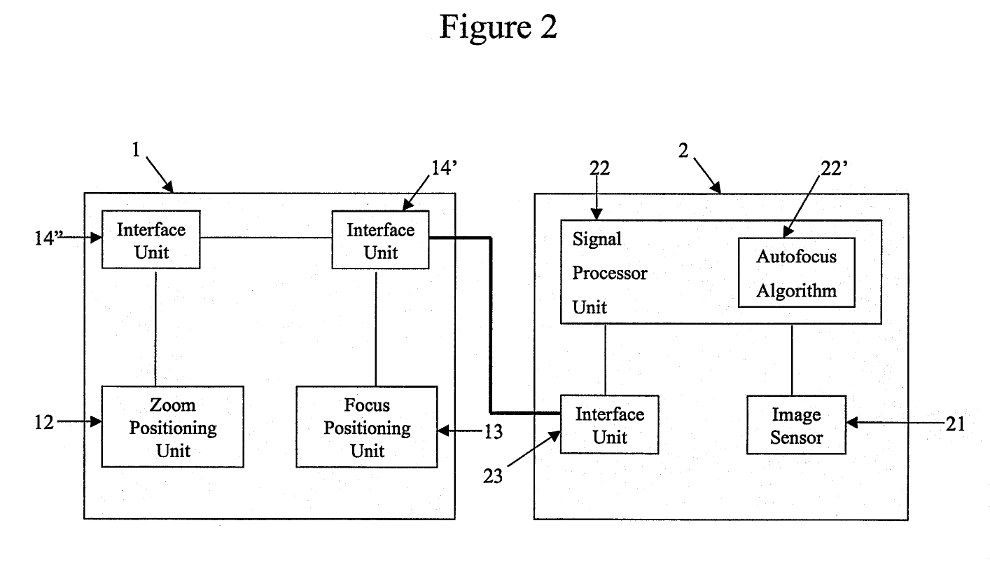

FIG. 2 shows another embodiment according to the present invention, in which microscope 1 does not comprise a separate control unit (i.e., the “intelligence” is completely “displaced” into camera unit 2). Instead, two interface units 14′ and 14″ are provided, which are controlled directly via interface 23 of camera unit 2, so that all the signal processing for focusing and zoom adjustment is performed by signal processor unit 22 of camera unit 2. A further considerable cost saving may result therefrom.

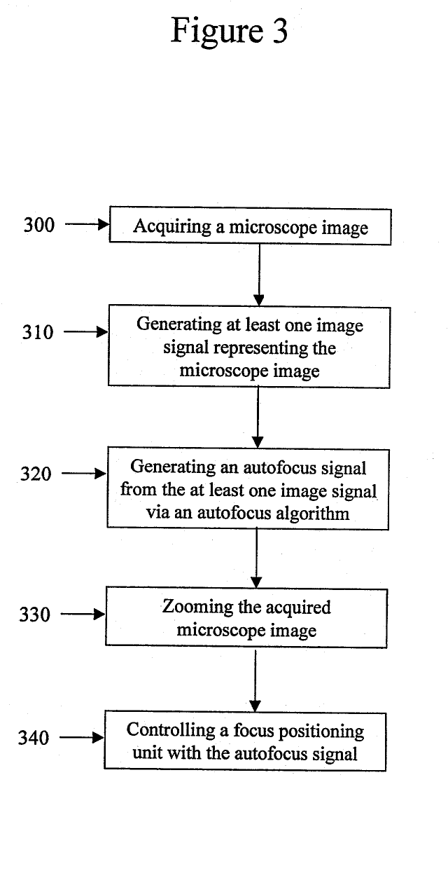

A flow chart showing a method of focusing a microscope using an electronic camera according to another embodiment of the present invention is shown in FIG. 3. According to this embodiment, the microscope system acquires a microscope image in step 300, preferably using an electronic camera (e.g., a digital camera). The digital camera generates at least one image signal representing the microscope image in step 310, preferably using a charge couple device (CCD) in the digital camera.

As similarly described above in reference to other embodiments, the digital camera generates an autofocus signal from the image signal via an algorithm in step 320. The autofocus signal is then used to zoom in to the acquired microscope image in step 330. This step 330 may be deleted if zoom adjustment is not desired. Preferably, the autofocus signal is also used to control a focus positioning unit (e.g., a focus device or changer). The above referenced method provides for considerable cost savings and less complexity over conventional methods.

Many modifications and variations may be made to the techniques and structures described and illustrated herein without departing from the spirit and scope of the invention. Accordingly, it should be understood that the methods and apparatus described herein are illustrative only and are not limiting upon the scope of the invention.

For example, instead of one image sensor 21 it is possible to use two or three image sensors. In addition, it is not absolutely necessary to use signal processors as control units 22 in camera unit 2; any desired processors, such as microprocessors or microcontrollers or other circuits, can be used instead.

The determination of the focus state of the microscope objectives can be accomplished with a very wide variety of novel methhods and also methods known in principle from the existing art.

In addition, signal processor unit 22 can not only read out the signals representing the image but also process the signals in such a way that they can be displayed on a monitor, and optionally can also perform image processing operations.

PARTS LIST

| | |
|---|---|
| 1 | Microscope |
| 2 | Camera unit |
| 11 | Microscope control unit |
| 12 | Zoom positioning unit |
| 13 | Focus positioning unit |
| 14 | Interface unit |
| 14′ and 14″ | Interface units |
| 21 | Image sensor |
| 22 | Signal processor unit |
| 22′ | Autofocus algorithm |
| 23 | Interface unit |

What is claimed is:

1. A microscope system comprising:
a focus positioning system for positioning at least one microscope objective; and
an electronic camera unit comprising:
at least one image sensor for generating an acquisition signal representing an acquired microscope image; and
a control unit for generating a control signal for said positioning system from said acquisition signal;
wherein an autofocus algorithm is implemented in said control unit to generate said control signal from said acquisition signal.

2. The microscope system as defined in claim 1, wherein said control unit comprises a signal processor unit.

3. The microscope system as defined in claim 1, wherein said electronic camera unit comprises a digital camera and said control unit comprises a charge couple device control unit within said digital camera.

4. The microscope system as defined in claim 1, wherein said microscope system is a stereomicroscope.

5. The microscope system as defined in claim 1, wherein said microscope objective is arranged on an objective changer.

6. The microscope system as defined in claim 1, wherein said microscope objective comprises a zoom objective.

7. The microscope system as defined in claim 6, further comprising an objective control unit to which said control signal is applied, said objective control unit controlling said positioning system.

8. The microscope system as defined in claim 7, wherein said objective control unit sets a focal length of said zoom objective.

9. The microscope system as defined in claim 7, wherein both said electronic camera unit and said objective control unit each include an interface unit through which they are connected.

10. The microscope system as defined in claim 1, further comprising a focus interface unit coupled to said focus positioning system, said focus interface unit directly receiving said control signal.

11. The microscope system as defined in claim 10, wherein said electronic camera unit further comprises a focus interface unit, and wherein said control unit directly controls said focus positioning system via said focus interface unit.

12. The microscope system as defined in claim 1, wherein said electronic camera unit is arranged in one of a beam path of a microscope and on an eyepiece of a microscope.

13. A program product for autofocusing a microscope with an electronic camera, said program product comprising computer readable program code for carrying out the following method steps:
acquiring a microscope image;
generating at least one image signal representing said microscope image;
generating an autofocus signal from said at least one image signal via an autofocus algorithm in the electronic camera; and
controlling a focus positioning unit with said autofocus signal.

14. The program product of claim 13, wherein said computer readable program code further carries out a step of zooming said acquired microscopic image.

15. The program product of claim 13, wherein said computer readable program code further carries out a step of controlling a focal length of a zoom device.

16. The program product of claim 13, wherein said electronic camera comprises a camera control unit arranged in a beam path of said microscope.

17. The program product of claim 13, wherein said electronic camera comprises a camera control unit, said camera control unit being arranged on an eyepiece of said microscope.

18. A computer readable disc comprising machine readable program code for causing a microscope including an electronic camera to perform the following method steps:
acquiring a microscope image;
generating at least one image signal representing said microscope image;
generating an autofocus signal from said at least one image signal via an autofocus algorithm in the electronic camera; and
controlling a focus positioning unit with said autofocus signal.

19. The computer readable disc of claim 18, wherein said machine readable program code further causes said microscope to perform a step of zooming said acquired microscopic image.

20. The computer readable disc of claim 18, wherein said machine readable program code further causes said microscope to perform a step of controlling a focal length of a zoom device.

21. The computer readable disc of claim 18, wherein said electronic camera comprises a camera control unit arranged in a beam path of said microscope.

22. The computer readable disc of claim 18, wherein said electronic camera comprises a camera control unit, said camera control unit being arranged on an eyepiece of said microscope.

23. A method of focusing a microscope using an electronic camera comprising the steps of:
acquiring a microscope image;
generating at least one image signal representing said microscope image;
generating an autofocus signal from said at least one image signal via an autofocus algorithm in the electronic camera; and
controlling a focus positioning unit with said autofocus signal.

24. The method of claim 23, further comprising zooming said acquired microscopic image.

25. The method of claim 23, further comprising controlling a focal length of a zoom device.

26. The method of claim 23, wherein said electronic camera comprises a camera control unit arranged in a beam path of said microscope.

27. The method of claim 23, wherein said electronic camera comprises a camera control unit, said camera control unit being arranged on an eyepiece of said microscope.
